(19) United States
(12) Patent Application Publication
(10) Pub. No.: US 2017/0066146 A1
(43) Pub. Date: Mar. 9, 2017

(54) MULTI-CUTTER KNIFE

(71) Applicant: BRADLEY CLEMENS, ALAMOGORDO, NM (US)

(72) Inventor: BRADLEY CLEMENS, ALAMOGORDO, NM (US)

(21) Appl. No.: 14/845,284

(22) Filed: Sep. 4, 2015

(51) Int. Cl. B26B 5/00

(52) U.S. Cl. CPC B26B 5/008

(57) ABSTRACT

The present invention discloses a new product that saves time while maintaining consistency in the sizes of the portions the user is cutting. The present invention provides a fast and efficient way to cut foods, like jelly, brownies, corn bread and sheet cake into uniformly-sized portions by being able to cut a whole sheet of product with just two cuts, one vertically and one horizontally across the pan. The portions will be of equal sizes and with neat straight lines and hence eliminates the wasting of ingredients and product by not being able to serve inconsistent portions and those which are not cut neatly. The chow lines will move much faster when perfectly-sized portions is cut and served quickly.

### FIELD OF THE INVENTION

The present invention relates generally to a device that is a tool to be used for making perfectly straight lines while saving time when cutting sheets of foods, like brownies, jelly, cornbread, and sheet cakes. It will also ensure that the portions are equal, so customers will be happy, and no product is wasted because the pieces are too small or have a messy appearance.

### BACKGROUND OF THE INVENTION

When working in the food service industry, controlling costs while maintaining quality is extremely important. When serving food products that are prepared on baking sheets, like cornbread, jelly, brownies and sheet cakes, individual portions that are cut and served should all be the same size and look presentable. This is hard to accomplish when using a knife to cut each piece, and the speed for serving these foods is decreased enormously by having to cut each piece separately, which is undesirable.

### SUMMARY OF THE INVENTION

The present invention discloses a new multi-cutter knife that saves time while maintaining consistency in the sizes of the portions, which the user is cutting. The present invention provides a fast and efficient way to cut foods, like jelly, brownies, corn bread and sheet cake into uniformly-sized portions by being able to cut a whole sheet of product with just two cuts, one vertically and one horizontally across the pan. The portions will be of equal sizes and with neat straight lines and hence eliminates the wasting of ingredients and product by not being able to serve inconsistent portions and those which are not cut neatly. The chow lines will move much faster when perfectly-sized portions is cut and served quickly. Moreover, the present invention discloses a new multi-cutter knife wherein the at-least one knife is removable.

### BRIEF DESCRIPTION OF THE DRAWINGS

FIG. 1 is an isometric view of the multi-cutter 1.

FIG. 2 is a front view of the multi-cutter 1.

FIG. 3 is a top view of the multi-cutter 1.

FIG. 4 illustrates a coupling wing 5 which is used to couple the knife 4 with the base 2 of the multi-cutter 1.

FIG. 5a illustrates a base of the multi-cutter 1 wherein the base 2 comprises grooves 2b and wedge shape coupling means 2a.

FIG. 5b illustrates a side view of the knife 4.

FIG. 5c illustrates a side view of the knife 4 coupled with the base 2 of the multi-cutter 1.

FIG. 5d illustrates an isometric view of the multi-cutter 1 having knives 4 coupled with the base 2.

FIG. 6a illustrates a base 2 of the multi-cutter 1 wherein the base 2 comprises multiple grooves 6.

FIG. 6b illustrates a side view of the knife 4.

FIG. 6c illustrates a side view of the knife 4 coupled with the base 2 of the multi-cutter 1.

FIG. 6d illustrates an isometric view of the multi-cutter 1 having knives 4 coupled with the base 2.

FIG. 7a illustrates a base of the multi-cutter 1 wherein the base 2 is having wedge shape coupling means 2a.

FIG. 7b illustrates a side view of the knife 4.

FIG. 7c illustrates a side view of the knife 4 coupled with the base 2 of the multi-cutter 1.

FIG. 7d illustrates an isometric view of the multi-cutter 1 having knives 4 coupled with the base 2.

### DETAIL DESCRIPTION OF THE INVENTION

All illustrations of the drawings are for the purpose of describing selected versions of the present invention and are not intended to limit the scope of the present invention.

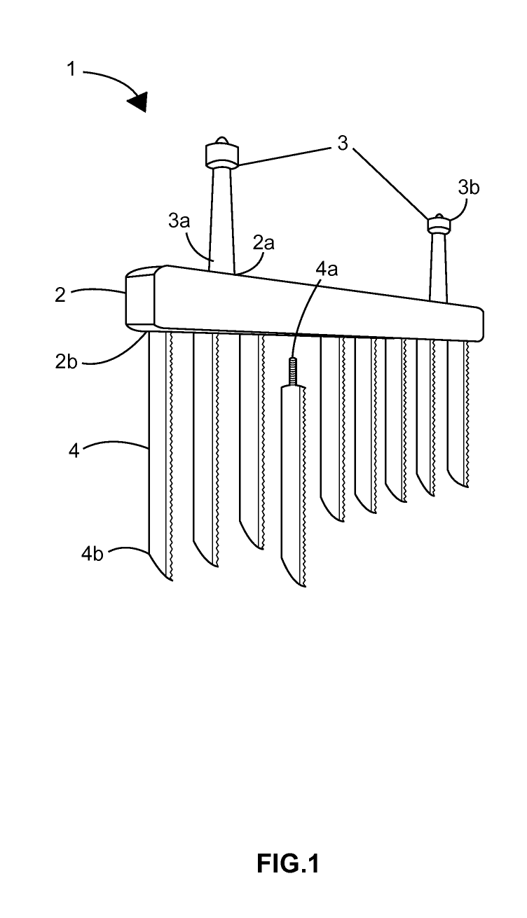

FIG. 1 represents the present invention which discloses a multi-cutter 1 wherein the multi-cutter 1 comprises a base 2, a handle 3, and at least two cutting knifes 4. The multi-cutter 1 is designed to make it easier and faster to cut and serve food items, like brownies, jelly, corn bread and sheet cake. A first end 3a of a handle 3 is coupled to a first side 2a of the base 2 and a second end 3b of the handle 3 enables the user to hold on it. Moreover, a first end 4a of the each knife 4 is coupled to a second side 2b of the base 2 and the second end 4b of the each knife 4 is enabled to cut the food items.

However, it is within the scope of the invention that the each knife 4 is enabled to be removed from the base 2 of the multi-cutter 1. Also, the knives 4 can be of different shape or size or are present to solve a different purpose. Moreover, first end 3a at least one handle 3 is attached to the first side 2a of the base 2 of the multi-cutter 1.

In one example of the present invention, the base consists of several cutting knives 4 attached to the second side 2b of the base 2. The user grasps the second end 3b of the handles 3 and slides the cutting knives 4 across the pan in one direction, cutting uniformly-sized rows. The pan is then turned, and the user cuts across the rows to create perfectly-sized portions quickly and easily. It is within the scope of the invention that the multi-cutter 1 can be of different sizes for use on different-sized pans.

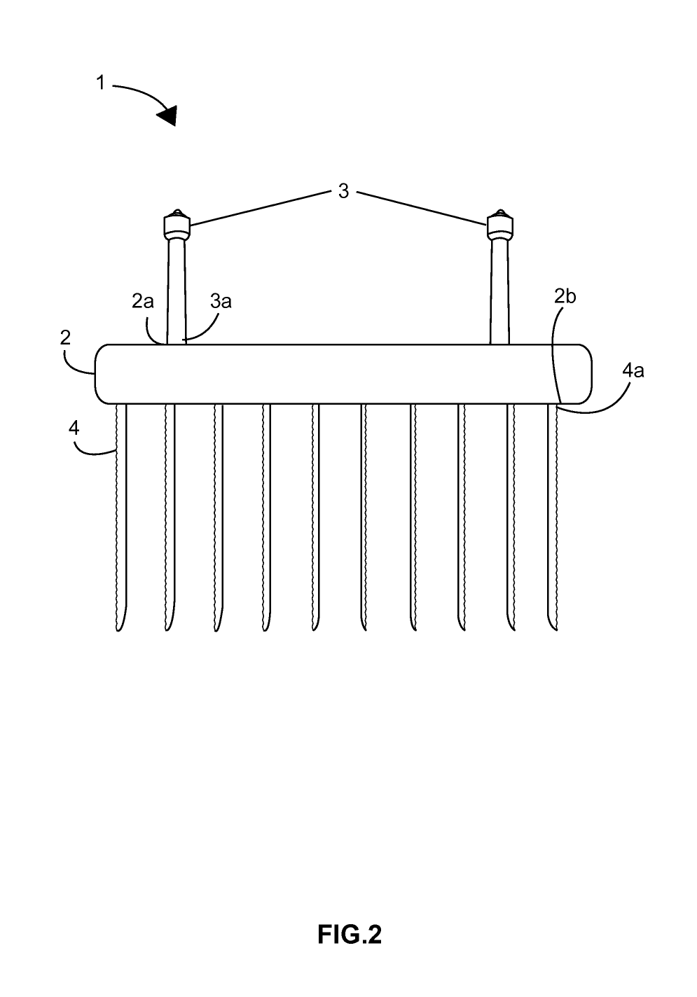

FIG.2 represents the side view of the multi-cutter 1 wherein the first end 4a of the knife 4 is coupled to the second side 2b of the base 2 of the multi-cutter 1. Moreover, first end 4a at least one handle 4 is coupled to the first side 2a of the base 2 of the multi-cutter 1.

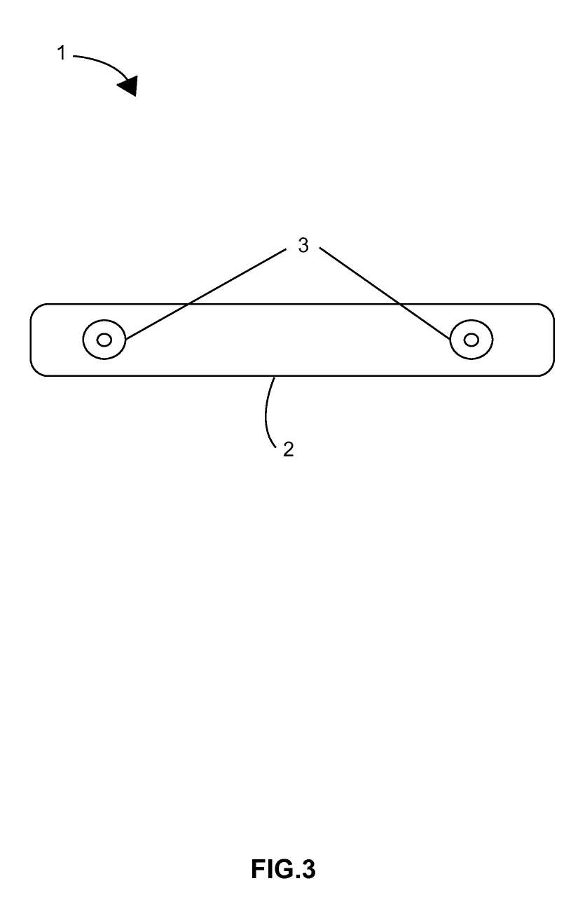

FIG. 3 represents the top view of the multi-cutter 1 wherein the handle 4 is coupled to the first side 2a of the base 2 of the multi-cuter 1.

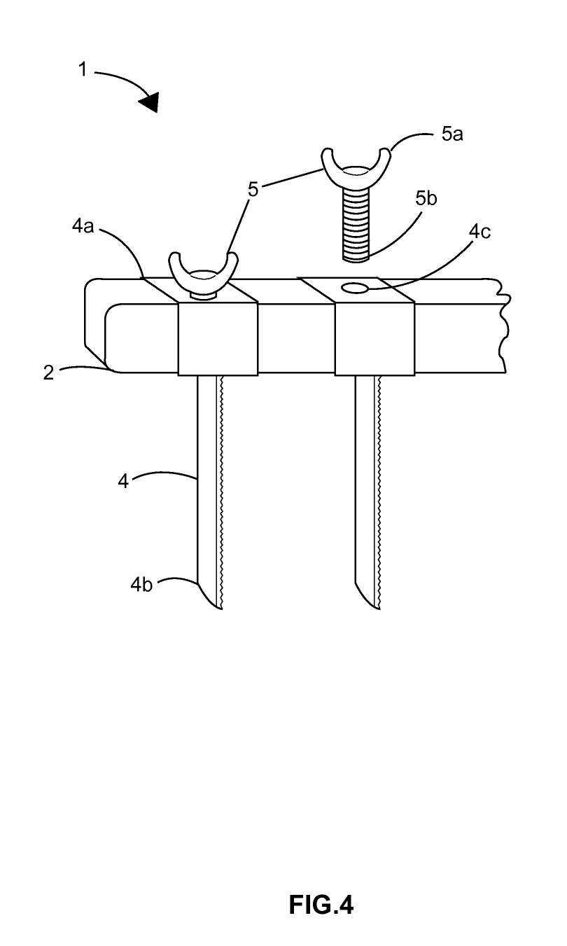

FIG. 4 illustrates a coupling wing 5 which is used to couple the knife 4 with the base 2 of the multi-cutter 1. First end 4a of the knife 4 is enabled to couple to the base 2 of the multi-cutter 1 wherein the wing 5 is provided to couple the first end 4a of the knife 4 with the base 2. Wing 5 is a screw-threaded and its second end 5b is enabled to couple with the opening 4c of first end 4a of knife 4. User actuates the first end 5a of the wing 5 to couple the knife 4 with the base 2.

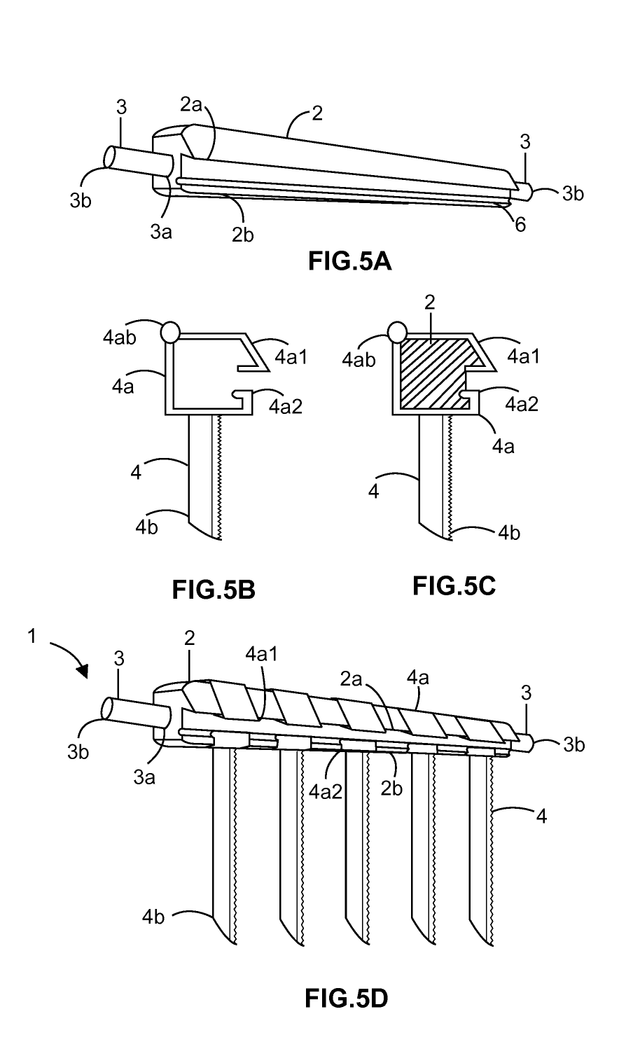

FIG. 5a illustrates a base of the multi-cutter 1 wherein the base 2 comprises grooves 6 and wedge shape coupling means 2a. Handle 3 are connected on the base 2 wherein the first end 3a of the handle 3 is coupled with the base 2 and second end 3b of the handle 3 is made available for the user to hold it. Wedge shape coupling means 2a is provided on the base 2 so as to provide better gripping to the knife 4. Moreover, grooves 6 are provided on the base 2 so as to provide better and stable gripping to the knife 4.

FIG. 5b is a side view of the knife 4. The first end 4a of the knife 4 comprises a hook coupling 4a1 to couple with the wedge shape coupling means 2a of the base 2. The first end 4a of the knife 4 further comprises a protrusion 4a2 to couple with the groove 6 of the base 2. The first end 4a further comprises a pivot 4ab to enable the user to couple the knife 4 with the base 2.

FIG. 5c is a side view of the knife 4 coupled with the base 2 of the multi-cutter 1. The hook coupling 4a1 is coupled with the wedge shape coupling of the base 2 and a protrusion 4a2 is coupled with the groove 6 of the base 2.

FIG. 5d is an isometric view of the multi-cutter 1 with the multiple knives 4 coupled with the base 2.

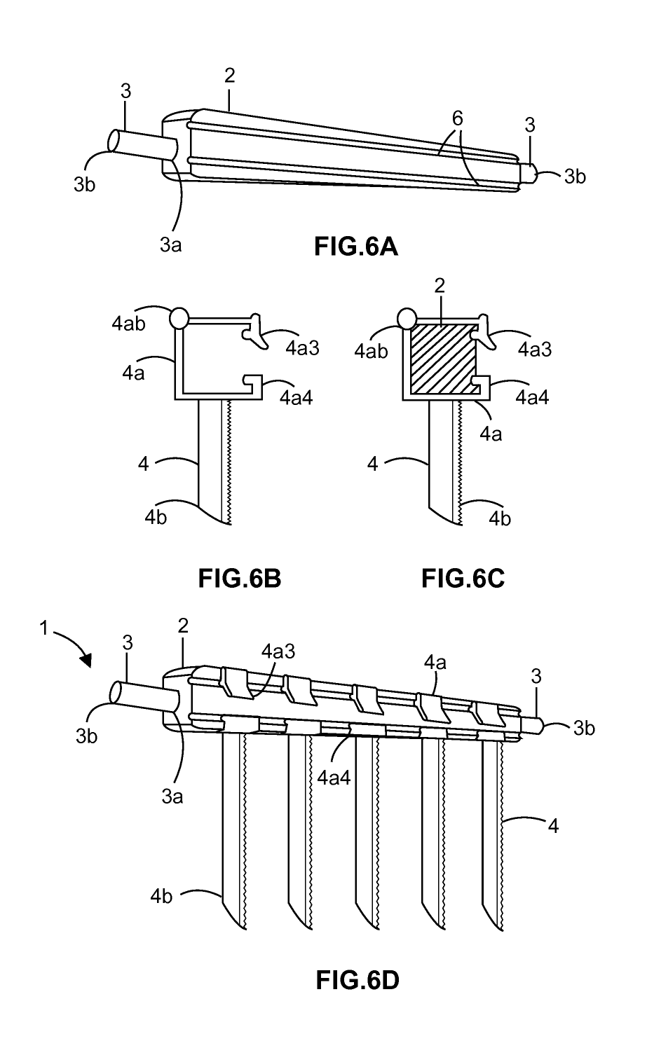

FIG. 6a illustrates a base of the multi-cutter 1 wherein the base 2 comprises multiple rows of grooves 2b. Handle 3 are connected on the base 2 wherein the first end 3a of the handle 3 is coupled with the base 2 and second end 3b of the handle 3 is made available for the user to hold it. Multiple rows of grooves 6 are provided on the base 2 so as to provide better and stable gripping to the knife 4.

FIG. 6b is a side view of the knife 4. The first end 4a of the knife 4 comprises a first protrusion 4a3 and second protrusion 4a4 wherein the first protrusion 4a3 and second protrusion 4a4 is enabled to couple with the groove 6 of the base 2. The first end 4a further comprises a pivot 4ab to enable the user to couple the knife 4 with the base 2.

FIG. 6c is a side view of the knife 4 coupled with the base 2 of the multi-cutter 1. The first protrusion 4a3 and second protrusion 4a4 is coupled with the groove 6 of the base 2.

FIG. 6d is an isometric view of the multi-cutter 1 with the multiple knives 4 coupled with the base 2.

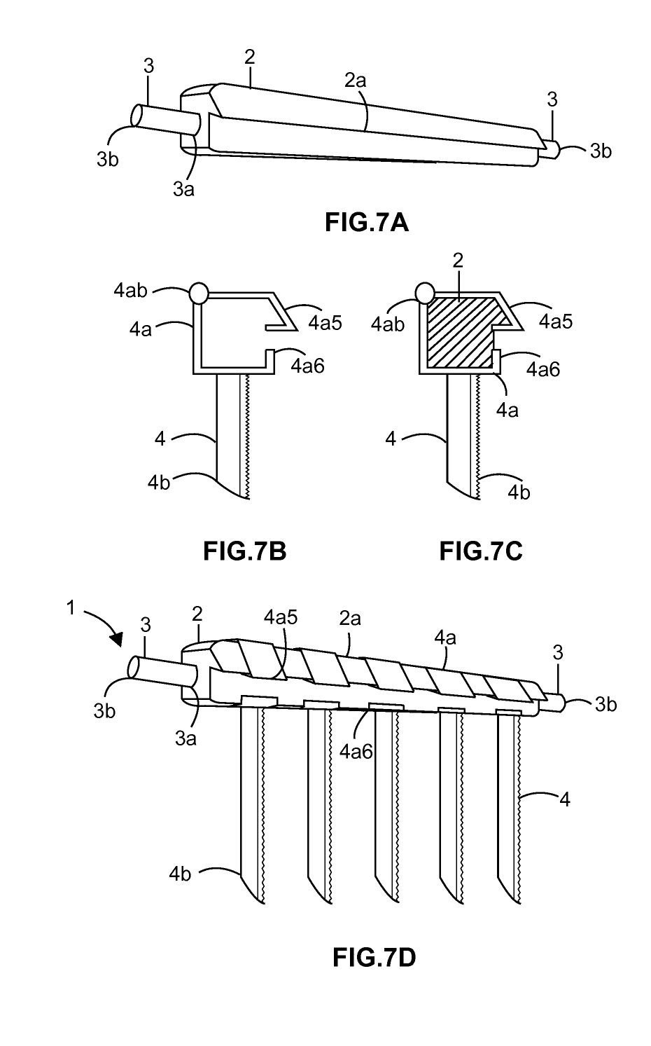

FIG. 7a illustrates a base of the multi-cutter 1 wherein the base 2 a wedge shape coupling means 2a. Handle 3 are connected on the base 2 wherein the first end 3a of the handle 3 is coupled with the base 2 and second end 3b of the handle 3 is made available for the user to hold it. Wedge shape coupling means 2a is provided on the base 2 so as to provide better and stable gripping to the knife 4.

FIG. 7b is a side view of the knife 4. The first end 4a of the knife 4 comprises a hook element 4a5 and a holding element 4a6 wherein the hook element 4a5 is enabled to couple with the wedge shape 2a of the base 2. The first end 4a further comprises a pivot 4ab to enable the user to couple the knife 4 with the base 2.

FIG. 7c is a side view of the knife 4 coupled with the base 2 of the multi-cutter 1. The hook element 4a5 is coupled with the wedge shape 2a of the base 2 and holding element 4a6 coupled to the side 2b of the base 2.

FIG. 7d is an isometric view of the multi-cutter 1 with the multiple knives 4 coupled with the base 2.

Although the invention has been explained in relation to its preferred embodiment, it is to be understood that many other possible modifications and variations can be made without departing from the spirit and scope of the invention.

1. A base, wherein a first side of the base is enabled to couple with a first end of at least one handle and a second side of the base is enabled to removable couple with a first end of each of at least two knives.

2. The multi-cutter of claim 1, wherein the second side of the base comprises internal coupling threads.

3. The multi-cutter of claim 1, wherein the first end of at least one knife comprises external threads to couple with the second side of the base unit.

4. The multi-cutter of claim 1, wherein the first end of at least one knife is removable from the second side of the base.

5. The multi-cutter of claim 1, wherein the base comprises at least one a wedge shape coupling means, at least one groove and at least one hole, wherein the wedge shape coupling means is enabled to couple with a hook element of the knife, the at least one groove is enabled to couple with at least one protrusion of the knife and at least one hole to receive the wing coupling means to couple a first end of the knife with the base.

6. The multi-cutter of claim 1, wherein a first end of the knife comprises at least one of the hook element, the at least one protrusion and at least one coupling element with a centralized hole.

7. The multi-cutter of claim 1, wherein at least one knife is removable from the multi-cutter by decoupling the coupling means of the corresponding knife from the base unit.

8. A multi-cutter comprises:
A base, wherein a first side of the base is enabled to couple with a first end of at least one handle, wherein at least one side of the base comprises at least one of a wedge shape coupling means, at least one groove and at least one hole, wherein the wedge shape coupling means is enabled to couple with a hook element of the knife, the at least one groove is enabled to couple with at least one protrusion of the knife and at least one hole to receive the wing coupling means to couple a first end of the knife with the base.

9. The multi-cutter of claim 8, wherein a first end of the knife comprises at least one of the hook element, the at least one protrusion and at least one coupling element with a centralized hole.

10. The multi-cutter of claim 8, wherein a second end of the wing coupling means is a threaded externally and is enabled to couple with the hole in the base unit in order to couple the first end of the knife.

11. The multi-cutter of claim 8, wherein at least one knife is removable from the multi-cutter by decoupling the coupling means of the corresponding knife from the base unit.

12. The multi-cutter of claim 8, wherein the first end of at least one knife is situated at equal distance from another knife.

13. The multi-cuter of claim 8, wherein the first of at least one knife is situated at variable distance from another knife.
